(19) United States
(12) Patent Application Publication
(10) Pub. No.: US 2007/0136787 A1
(43) Pub. Date: Jun. 14, 2007

(54) System and method for restricting and authorizing the use of software printing resources

(75) Inventors: Alex Chungshi Chen, Arcadia, CA (US); Rene Robles, Santa Maria, CA (US); George K. Hartupee JR., Racho Cucamonga, CA (US)

Correspondence Address: George Likourezos, Esq;c/o Carter, DeLuca, Farrell & Schmidt, LLP, 445 Broadhollow Road - Suite 225, Melville, NY, 11747, US

(73) Assignee: Xerox Corporation

(21) Appl. No.: 11/301,427

(22) Filed: Dec. 13, 2005

(51) Int. Cl. H04L 9/32

(52) U.S. Cl. 726/3

(57) ABSTRACT

A method and system are provided for authorizing access to software printing resources stored within a memory of a network printing system. The method and system receive user identification information and a request for access to at least one software printing resource of the software printing resources. A determination is then made whether the user identification information corresponds to an authorized user. If the user identification information corresponds to an authorized user, access is given to the at least one software printing resource stored within the memory, thereby enabling the performance of a print job using the at least one software printing resource.

### BACKGROUND

The present disclosure relates to network printing systems, and more specifically, to a system and method for restricting and authorizing the use of software printing resources, such as fonts and files, used, among other things, for printing magnetic ink character recognition (MICR) characters and other characters having specialized or proprietary fonts, as well as documents having a proprietary format, design or look.

Printing devices, such as xerographic printers and ink-jet printers, are common. These printers can be used to print documents with magnetic-ink, in order to print MICR characters thereon. MICR characters are numerical characters which are typically printed at the bottom of a check and form an MICR font strip. MICR characters are printed using an ink containing magnetic material, so that when the MICR font strip is scanned by a magnetic read-head, each MICR character creates a unique, identifiable magnetic flux pattern in the read-head.

Since each MICR character (such as the numbers 0-9) has a unique magnetic flux pattern associated therewith, the MICR characters can be read and processed quickly by an automated check-reading and processing system. In the United States, the font typically used for printing MICR characters is “E13B,” while in other countries the font used for printing MICR characters is “CMC7.”

Because MICR characters and other specialized and proprietary fonts are often used to create sensitive documents, such as checks, and print proprietary indicia, such as a corporate logo, security measures are often provided to prevent the creation or printing of fraudulent or unauthorized documents having MICR characters or other characters created using a specialized font. In the context of digital printing, security measures for preventing unauthorized creation or printing of characters having a specialized font, such as the font used to create MICR characters, typically include restricting (a) access to the printing apparatus capable of printing characters with the specialized font, such as MICR characters and/or other characters; and/or (b) restricting access to the magnetic- or metallic-based printing material, such as toner or liquid ink.

For a large-scale work-group network printing system, the network printing system may be used by a large number of networked users for general purposes, such as printing non-sensitive documents. In this situation, security measures typically provide for preventing the unauthorized printing of sensitive documents, i.e., documents having characters with specialized fonts, such as MICR fonts (E13B and CMC7) and other specialized and proprietary fonts, and documents having a particular format, design or look, while allowing the printing of non-sensitive documents.

For example, a large-scale network printing system may provide a plurality of marking devices, such as xerographic development units or ink-jet ink supplies, only one of which includes the magnetic-based marking material for printing sensitive documents. Therefore, security measures provide for restricting access to the marking device having the magnetic-based marking material while allowing access to the non-magnetic based marking material. Access may be restricted, for example, by having an authorized user swipe an authorization card through a scanner/reader and/or by physically locking the network printing system, such as with a lock and key or by providing a firewall, in order to prevent unauthorized use of the magnetic-based marking material.

Another security measure which does not call for adding a scanner/reader or firewall to the network printing system provides for an authorized user to import or download software printing resources, e.g., fonts and files for use in printing MICR characters and other characters having proprietary or specialized fonts, to a processor of the network printing system from a diskette or CD-ROM before performing a print job. The imported printing resources are then deleted from a memory of the processor after the print job is completed to prevent misuse and unauthorized use.

The prior art methods for safeguarding against misuse and unauthorized use of sensitive software printing resources are either costly (adding hardware to the network printing system) and not user-friendly and efficient (importing software printing resources prior to performing a print job). Accordingly, it is an aspect of the present disclosure to provide a system and method for restricting and authorizing the use of software printing resources, especially fonts and files for printing sensitive documents, which overcome the drawbacks of the prior art.

### SUMMARY

According to the present disclosure, there are provided a system and method for restricting and authorizing the use of software printing resources, especially fonts and files for printing sensitive documents, i.e., documents having characters with specialized fonts, such as MICR fonts (E13B and CMC7) and other specialized and proprietary fonts, and documents having a particular format, design or look. In particular, the software printing resources include bitmap font files which cause a printing apparatus to print characters of a particular font(s). The software printing resources further include software which causes a printing apparatus to print a document having a particular format, design, or look. The software printing resources can also include software which causes the printing apparatus to print encoded indicia, such as DataGlyphs™ developed by the Xerox Corporation.

According to an aspect of the present disclosure, there is provided a method for authorizing access to software printing resources stored within a memory of a network printing system. The method includes receiving by at least one processor of the network printing system user identification information and a request for access to at least one software printing resource of the software printing resources. The method further includes determining whether the user identification information corresponds to an authorized user, and accessing the at least one software printing resource from the memory, if the user identification information corresponds to an authorized user. The method then provides for performing a print job using the at least one software printing resource.

According to another aspect of the disclosure, a network printing system is provided having at least one software printing resource requiring authorization for use thereof. The network printing system further includes at least one processor for executing a set of instructions for determining whether a user is an authorized user of the at least one software printing resource, providing access to the at least one software printing resource via a network connection if it is determined that the user is an authorized user, and performing a print job using the at least one software printing resource.

According to another aspect of the present disclosure, a computer-readable storage medium is provided storing a set of instructions capable of being executed by at least one processor of a network printing system having a memory storing software printing resources. By executing the set of instructions, the at least one processor receives user identification information and a request for access to at least one software printing resource of the software printing resources. A determination is then made whether the user identification information corresponds to an authorized user. If the user identification information corresponds to an authorized user, access is provided to the at least one software printing resource stored within the memory, thereby enabling the performance of a print job using the at least one software printing resource.

### BRIEF DESCRIPTION OF THE DRAWINGS

Various embodiments of the present disclosure will be described herein below with reference to the figures wherein:

FIG. 1 is a system diagram showing elements of a network printing system of which the present technology may be applied;

FIG. 2 is a schematic representation of a method for setting up the system and method according to the present disclosure;

FIG. 3 illustrates a flow diagram for accessing and using software printing resources for printing sensitive documents according to the present disclosure; and

FIG. 4 illustrates a look-up table according to the present disclosure.

### DETAILED DESCRIPTION

Embodiments of the present disclosure will be described herein below with reference to the accompanying drawings. In the following description, well-known functions or constructions are not described in detail to avoid obscuring the present disclosure in unnecessary detail.

The word “printer” and the term “printing system” as used herein encompass any apparatus and/or system, such as a digital copier, xerographic and reprographic printing systems, bookmaking machine, facsimile machine, multi-function machine, etc. which perform a print outputting function for any purpose.

The system and method of the present disclosure could be utilized for printing sensitive documents, i.e., documents having characters with specialized fonts, such as MICR fonts (E13B and CMC7) and other specialized and proprietary fonts, and documents having a particular format, design or look. Documents which could be printed using the system and method of the present disclosure include but not limited to checks, stock or bond certificates, driver's licenses, identification cards or papers, passports, betting slips, prize or game awards, tickets, or documents that simply require validating signatures to be affixed thereto, such as contractual agreements.

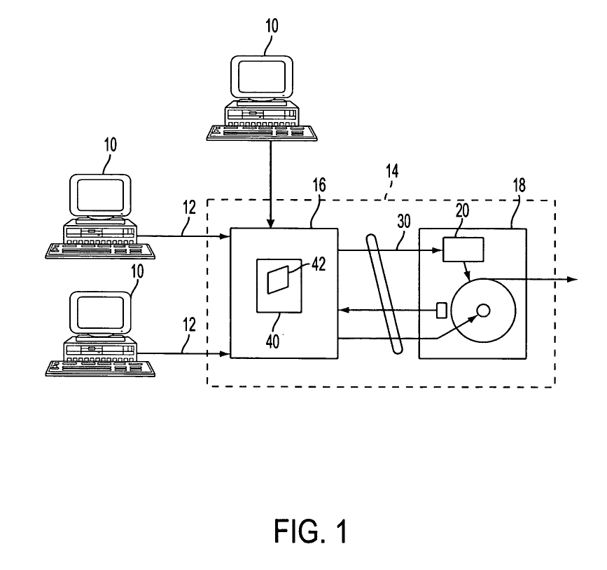

FIG. 1 is a diagram showing the elements of a network printing system 50 in which the present technology may be applied. At least two computer terminals 10, such as a personal computer are connected by a bus 12 to a printer 14. It is to be understood that the bus 12 could be connected to a network, such as the Internet, and that computers 10 may selectably address the printer 14 through the bus 12 by a network communications protocol, such as the TCP/IP protocol.

As illustrated in FIG. 1, printer 14 may be divided into two parts, an electronic subsystem (ESS) 16 and an image output terminal (IOT) 18. These two parts are generally provided for digital printers such as digital xerographic printers and printing systems.

A processor 40 communicates with one of the computer terminals 10 through a communications port, such as a parallel or USB port. The processor 40 may reside within the printer 14 (as shown in FIG. 1) or outside of the printer 14, such as within a server of the network printing system 50. The processor 40 is configured for running an operating system and/or other software for enabling the printer 14 to perform document production functionalities, such as for example, photocopying, scanning, printing, faxing functionalities, and other functions in accordance with the present disclosure.

The processor 40 includes a memory 42, such as EEPROM, RAM and ROM, for storing software and images of processed documents (e.g., images acquired during scanning, printing, copying, etc.). The memory 42 also stores software printing resources in accordance with the present disclosure. It is contemplated that the software printing resources can be stored within a server and/or database of the network printing system 50 in operative communication with the printer 14.

The term “software printing resources” is a term used herein which collectively includes but is not limited to fonts and files for printing sensitive documents, such as bitmap font files which cause a printing apparatus to print characters of a particular font(s); software which causes a printing apparatus to print a document having a particular format, design, or look; and software which causes the printing apparatus to print encoded indicia, such as DataGlyphs™ developed by the Xerox Corporation.

In accordance with the present disclosure, the bitmap font files and other software printing resources are encrypted and stored within the memory 42. The bitmap font files and other software printing resources can also be stored within a server/database and/or font repository in operative communication with the processor 40 through a network connection.

Using bitmaps to print characters in a desired font is generally how page description languages, such as HP-PCL (printer command language) and PostScript, print characters in a desired font. Accordingly, the processor 40 communicates with the computer terminals 10 using “page description language” where each computer terminal 10 outputs a set of characters in ASCII or similar format along with instructions to the processor 40 to render these characters in a particular desired font using at least one software printing resource, such as a bitmap font file. According to the particular font that is desired, one of the bitmap font files is accessed, decrypted and transmitted along video line 30 to imager 20 for printing a particular character(s) using the desired font. Other software printing resources can also be accessed, decrypted and transmitted along video line 30 to imager 20, such as, for example, software tools for printing the document in accordance with a proprietary format.

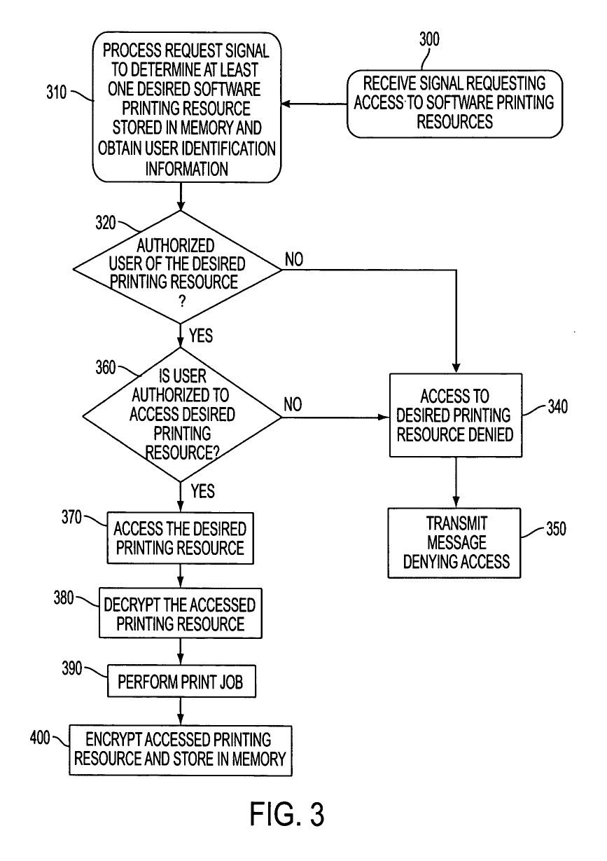

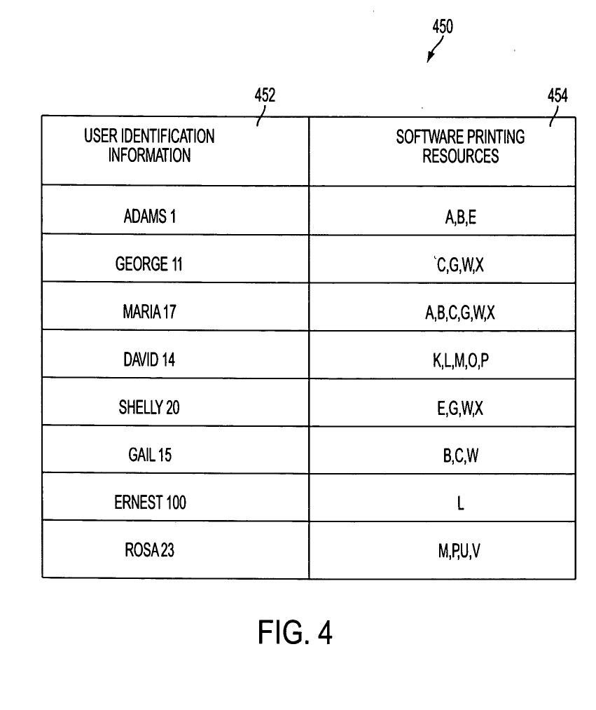

The memory 42 also stores user data in the form of a look-up table 450 (see FIG. 4) which correlates each user of the network printing system 50 with at least one printing resource stored by the memory 42 in which the user is authorized to access. The processor 40 accesses the look-up table as further described below with reference to FIG. 3 for determining if a particular user requesting access to at least one software printing resource is an authorized user of the at least one software printing resource.

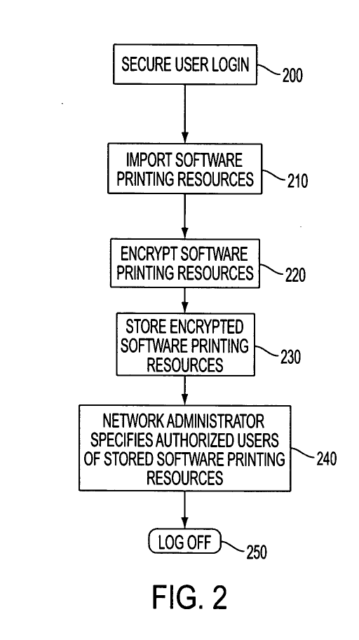

Referring now to FIG. 2, there is shown a process for storing software printing resources and administering access to the stored software printing resources in accordance with the present disclosure. First, a network administrator or other authorized individual logs in to the processor 40 of the network printing system 50 by providing user identification information, i.e., a valid user name and password (Step 200). After logging in to the processor 40, the network administrator via a graphical user interface of the network printing system 50 initiates the execution of application software by the processor 40 for importing the software printing resources within the network printing system 50 (Step 210) from a computer-readable medium, such as a CD-ROM, DVD, and diskette, or from another data storage device, such as from EEPROM, RAM and ROM.

The application software then encrypts the imported software printing resources and stores them within the memory 42 (Step 230). The software printing resources can be encrypted prior to storage in the memory 42 and decrypted for performing a print job as described below using symmetric key encryption or public key encryption. Both encryption/decryption methods are well known in the art.

The network administrator via the graphical user interface can then provide instructions to the processor 40 for continuing the execution of the application software for updating and/or making changes/edits to the look-up table 450, which is further described below with reference to FIG. 4, for denoting which individual users of the network printing system 50 are to have access to individual stored software printing resources (Step 240). It is contemplated that the network administrator can make changes and/or updates to the look-up table at any time as situations change, e.g., need to authorize a new employee to be able to access a bitmap font file; need to de-authorize a current employee who is leaving the company from accessing a software printing resource, need to authorize an employee access to a stored software printing resource for obtaining corporate indicia/logo for producing a corporate brochure, etc.

Finally, the process as shown by FIG. 3 provides for the network administrator to provide instructions to the processor 40 to terminate the execution of the application software, log off and save the changes/edits made to the look-up table (Step 250). It is provided that the updates and/or changes/edits to the look-up table are entered using a series of drop-down menus or windows displayed by the graphical user interface due to the execution of the application software.

Following the process shown by FIG. 2, the encrypted and stored software printing resources cannot be accessed by unauthorized users. The encrypted and stored software printing resources can only be accessed by authorized users. Each of the authorized user's user identification information is included in the look-up table 450 and correlated with at least one software printing resource which can be accessed by that authorized user as shown by FIG. 4.

FIG. 3 illustrates a flow diagram showing the process of accessing software printing resources stored within the memory 42 according to the present disclosure. At Step 300, a request signal is received by the processor 40 requesting access to stored software printing resources. The processor 40 processes the request signal using well-known signal analysis and processing methodologies to determine at least one stored software printing resource which is desired to be accessed (Step 310). The request signal can also include the print job desired to be performed by the printer 14. Alternatively, the print job can be transmitted to the printer 14 after the processor 40 processes the request signal and provides access to the at least one stored software printing resource, i.e., following Step 360.

At Step 320, the processor 40 determines whether the user identification information, which is received with the request signal as shown in FIG. 3 or after the request signal is received, is included in the look-up table stored in the memory 42. If the user identification information is included in the look-up table, then it is determined that the user is an authorized user of at least one stored software printing resource and the process continues to Step 330. Otherwise, the process continues to Step 340 where access to the at least one requested software printing resource encrypted and stored within the memory 42 is denied. A message is then transmitted to the user indicating that the network printing system 50 denies access to the at least one requested software printing resource (Step 350). The print job is then terminated.

After the print job is terminated, the print job can be resent to the processor 40 without the requirement of performing the print job with the use of the at least one previously requested software printing resource. Alternatively, the processor 40 performs the print job without requiring the print job to be resent, where the processor 40 substitutes a non-secure software printing resource (a printing resource which does not require the user to be an authorized user) for the at least one requested software printing resource.

If, however, in Step 320, it is determined that the user is an authorized user of at least one stored software printing resource, then at Step 360, the processor 40 determines whether the authorized user has authorization to access the at least one requested software printing resource. The determination is made by determining whether the look-up table correlates the received user identification information with the at least one requested software printing resource. If the user does not have authorization to access the at least one requested software printing resource, the process proceeds to Steps 340 and 350 which are described above.

If, however, in Step 360, it is determined that the user does have authorization to access the at least one requested software printing resource, then at Step 370, the processor 40 accesses the at least one requested software printing resource. At Step 380, the processor 40 then decrypts the at least one accessed software printing resource. Subsequently, at Step 390, the network printing system performs the print job using the at least one accessed software printing resource. After the print job is performed, the at least one accessed software printing resource is encrypted and stored in memory 42 at Step 400.

As shown by FIG. 4, the look-up table 450 correlates unique user identification information 452 identifying authorized users of the stored software printing resources with at least one software printing resource 454. It is contemplated that alternatively the user identification information identifies different work groups, where each work group has at least one authorized user assigned thereto, with at least one software printing resource. Prior to sending a print job to the printer 14, the user identification information can be inputted to the processor 40 using a touchpad of the printer 14 or a graphical user interface of one of the computers 10.

It is contemplated that the user identification information includes biometric information. The biometric information can include fingerprint information, a retinal scan, hand geometry scan, face scan, speech recognition and analysis, signature analysis, etc. It is also contemplated for the user identification information to include text data (e.g., user name and password) and biometric information.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

1. A method for authorizing access to software printing resources stored within a memory of a network printing system, the method comprising:
receiving by at least one processor of the network printing system user identification information and a request for access to at least one software printing resource of the software printing resources;
determining whether the user identification information corresponds to an authorized user;
accessing the at least one software printing resource stored within the memory, if the user identification information corresponds to an authorized user; and
performing a print job using the at least one software printing resource.

2. The method according to claim 1, wherein the software printing resources are selected from the group consisting of bitmap font files for printing characters of particular fonts; software for printing a document having a particular format; and
software for printing a document having encoded indicia.

3. The method according to claim 1, further comprising displaying a list of the stored software printing resources on a graphical user interface.

4. The method according to claim 1, further comprising:
encrypting the software printing resources prior to storing the software printing resources within the memory;
decrypting the at least one software printing resource prior to performing the print job; and
encrypting the at least one software printing resource after the performance of the print job.

5. The method according to claim 1, further comprising maintaining a look-up table correlating user identification information with authorized users of the stored software printing resources.

6. The method according to claim 1, wherein the user identification information is biometric information.

7. The method according to claim 1, wherein determining whether the user identification information corresponds to an authorized user comprises accessing a look-up table, the method further comprising restricting access to the at least one software printing resource if the user identification information does not correspond to an authorized user.

8. A network printing system comprising:
at least one software printing resource requiring authorization for use thereof; and
at least one processor for executing a set of instructions for determining whether a user is an authorized user of the at least one software printing resource, providing access to the at least one software printing resource via a network connection if it is determined that the user is an authorized user, and performing a print job using the at least one software printing resource.

9. The system according to claim 8, wherein the at least one software printing resource is selected from the group consisting of bitmap font files for printing characters of particular fonts; software for printing a document having a particular format; and software for printing a document having encoded indicia.

10. The system according to claim 8, wherein the execution of the set of instructions further comprises:
encrypting the at least one software printing resource prior to storing the at least one software printing resource within the at least one processor;
decrypting the at least one software printing resource prior to performing the print job; and
encrypting the at least one software printing resource after the performance of the print job.

11. The system according to claim 8, wherein execution of the set of instructions further comprises maintaining a look-up table correlating user identification information with authorized users of the at least one stored software printing resource.

12. The system according to claim 8, wherein the user identification information is biometric information.

13. The system according to claim 8, wherein determining whether the user identification information corresponds to an authorized user comprises accessing a look-up table, and restricting access to the at least one software printing resource if the user identification information does not correspond to an authorized user.

14. A computer-readable storage medium storing a set of instructions capable of being executed by at least one processor of a network printing system having a memory storing software printing resources for:
receiving by the at least one processor user identification information and a request for access to at least one software printing resource of the software printing resources;
determining whether the user identification information corresponds to an authorized user;
accessing the at least one software printing resource stored within the memory, if the user identification information corresponds to an authorized user; and
enabling the performance of a print job using the at least one software printing resource.

15. The computer-readable storage medium according to claim 14, wherein the software printing resources are selected from the group consisting of bitmap font files for printing characters of particular fonts; software for printing a document having a particular format; and software for printing a document having encoded indicia.

16. The computer-readable storage medium according to claim 14, wherein execution of the set of instructions further comprises displaying a list of the stored software printing resources on a graphical user interface of the network printing system.

17. The computer-readable storage medium according to claim 14, wherein execution of the set of instructions further comprises:
encrypting the software printing resources prior to storing the software printing resources within the memory;
decrypting the at least one software printing resource prior to performing the print job; and
encrypting the at least one software printing resource after the performance of the print job.

18. The computer-readable storage medium according to claim 14, wherein execution of the set of instructions further comprises maintaining a look-up table correlating user identification information with authorized users of the stored software printing resources.

19. The computer-readable storage medium according to claim 14, wherein the user identification information is biometric information.

20. The computer-readable storage medium according to claim 14, wherein determining whether the user identification information corresponds to an authorized user comprises accessing a look-up table, and restricting access to the at least one software printing resource if the user identification information does not correspond to an authorized user.
